(19) United States
(12) Patent Application Publication
(10) Pub. No.: US 2002/0113992 A1
(43) Pub. Date: Aug. 22, 2002

(54) Information conveying system and method, and storage medium thereof

(75) Inventors: Hiroyuki Takakura, Kawasaki (JP); Kenichiro Sakai, Kawasaki (JP); Satoshi Maeda, Kawasaki (JP); Tsugio Noda, Kawasaki (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 09/927,492

(22) Filed: Aug. 13, 2001

(30) Foreign Application Priority Data
Feb. 21, 2001 (JP) 2001-044627

(51) Int. Cl. G06F 15/00

(52) U.S. Cl. 358/1.15

(57) ABSTRACT

A storage program for smoothly conveying an information transmission destination and information, which are required at the time of an information exchange between an enterprise side and a consumer side, is converted into pattern information, and distributed to consumers. The storage program renders assistance for information conveyance that suits an environment surrounding the consumer side, for example, depending on whether or not to make a connection to a network, etc. Additionally, a prize by which winning/losing is determined on the spot can be implemented by storing an ID number of a prize draw winner in pattern information. According to the present invention, a bidirectional information exchange between an enterprise side and a consumer side can be smoothly made. At that time, troublesomeness of the operations of both the enterprise and the consumer sides can be reduced.

### BACKGROUND OF THE INVENTION

1. Field of the Invention

The present invention relates to an information conveying system for smoothly conveying diverse information that an enterprise side presents to a consumer side, and information that the consumer side conveys to the enterprise side, and for smoothly making a bidirectional information exchange between an enterprise and a consumer.

2. Description of the Related Art

At present, a method carrying information desired to be conveyed in a newspaper or a magazine, and obtaining a reply from a consumer is adopted as a method with which an information provider such as an enterprise or the like provides consumers with information, and obtains a reply to the information.

Furthermore, as one method with which an enterprise side (an information provider) acquires unique information from consumers, a prize questionnaire is conducted. With a prize questionnaire, an enterprise side acquires a variety of information from consumers by carrying a questionnaire in a magazine, a newspaper, an advertisement leaflet, etc. to conduct the questionnaire, and a consumer obtains a gift, etc. in return for a reply to the questionnaire.

When a consumer returns information to an information provider, the consumer can easily convey the information if he or she uses a terminal such as a personal computer, a cellular phone, etc., which is connected to a network. However, the following problems arise.

1) Inputting information of a conveyance destination such as a network address, etc. is a time-consuming job.

2) If information from an information provider is only characters, graphics, and photos, which are carried in a magazine, etc., they are insufficient for increasing an incentive of a consumer.

3) If there are a plurality of information reply destinations, a lot of paper space is occupied to list the destinations.

Additionally, a method of a conventional prize questionnaire has the following problems.

1) Since a consumer must send reply information of a questionnaire to an enterprise side via a postal card, facsimile, etc., it is troublesome to make an application. This troublesomeness also decreases a consumer incentive to participate in a questionnaire.

2) An application time period is preset, and a prize draw winner is selected from among applicants after the application time period elapses. Therefore, consumers must wait for a long time from when they reply to a questionnaire till when a prize draw winner is announced.

3) An enterprise side must manually add up replies to a questionnaire sent in the form of a postal card or facsimile.

Furthermore, a prize questionnaire is conducted on a Web page by using the Internet. Also in this case, consumers must wait for a long time from their applications, because a prize draw winner is announced after a preset application time period elapses.

### SUMMARY OF THE INVENTION

The present invention was developed to overcome the above described problems, and aims at providing an information conveying system and method having a mechanism for reducing the troublesomeness of both sponsor and application sides of a prize questionnaire.

Additionally, the present invention aims at providing an information conveying system and method for smoothly making a bidirectional information exchange between an enterprise, which is an information provider side, and a consumer, who is an application side.

Furthermore, the present invention aims at providing a prize drawing method that allows an applicant to verify the winning/losing of a prize on the spot as with an instant lottery, and reduces the troublesomeness of a consumer and a sponsor.

An information conveying method according to the present invention assumes a bidirectional information exchange made between information provider and consumer sides.

The information provider side converts conveyance information that the information provider side itself conveys to the consumer side into pattern information recording digital data.

The conveyance information includes at least one of (provision information that the information provider side provides to the consumer side?), return information for returning reply information, and a storage program for determining an environment surrounding the consumer side. The above described storage program returns the reply information, for example, by making a connection to a network if the consumer side can make the connection to the network, or presents information required for returning a reply with a method which does not make a connection to the network if the connection to the network cannot be made.

The consumer side restores the pattern information printed on a distribution material, and returns reply information of the conveyance information to the information provider side based on the conveyance information restored from the pattern information.

According to the present invention, information conveyance from a consumer side to an information provider side as well as information conveyance from the information provider side to the consumer side can be smoothly made. Additionally, the troublesomeness of the operations for conveying information on both the information provider and consumer sides can be reduced.

Furthermore, the conveyance information is configured to include information for determining the winning/losing of a prize, and a winning/losing determination program for determining the winning/losing of a prize based on the information for determining the winning/losing of a prize, and identification information set on the consumer side, thereby implementing a prize competition by which the winning/losing of a prize can be determined on the spot.

### BRIEF DESCRIPTION OF THE DRAWINGS

FIG. 1 explains the fundamental principle of preferred embodiments;

FIG. 2 exemplifies pattern information;

FIG. 3 explains BOOK IDs;

FIG. 4 explains information conveyance from a consumer side to an enterprise side, according to a preferred embodiment of the present invention;

FIG. 5 explains the procedures of a first preferred embodiment;

FIG. 6 is a conceptual drawing of an information conveying system according to a second preferred embodiment;

FIG. 7 explains the procedures of the information conveying system according to the second preferred embodiment;

FIG. 8 shows the information conveyance from a consumer side to an enterprise side in the second preferred embodiment;

FIG. 9 shows advantages that a system according to the present invention brings to an enterprise side, a consumer side, and a maker;

FIG. 10 is a flowchart showing the process performed by the information conveying system according to the first preferred embodiment;

FIG. 11 is a flowchart showing the process performed by the information conveying system according to the second preferred embodiment;

FIG. 12 is a flowchart showing an information notification process from a consumer side to an enterprise side;

FIG. 13 shows an information processing system environment in which a system according to the present invention is used; and

FIG. 14 exemplifies storage media.

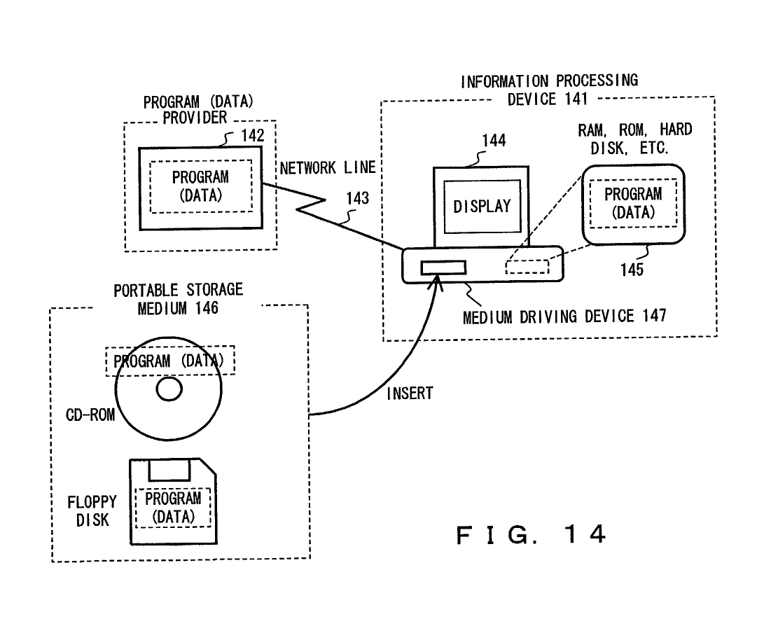

### DESCRIPTION OF THE PREFERRED EMBODIMENTS

Hereinafter, a preferred embodiment according to the present invention will be explained with reference to the drawings.

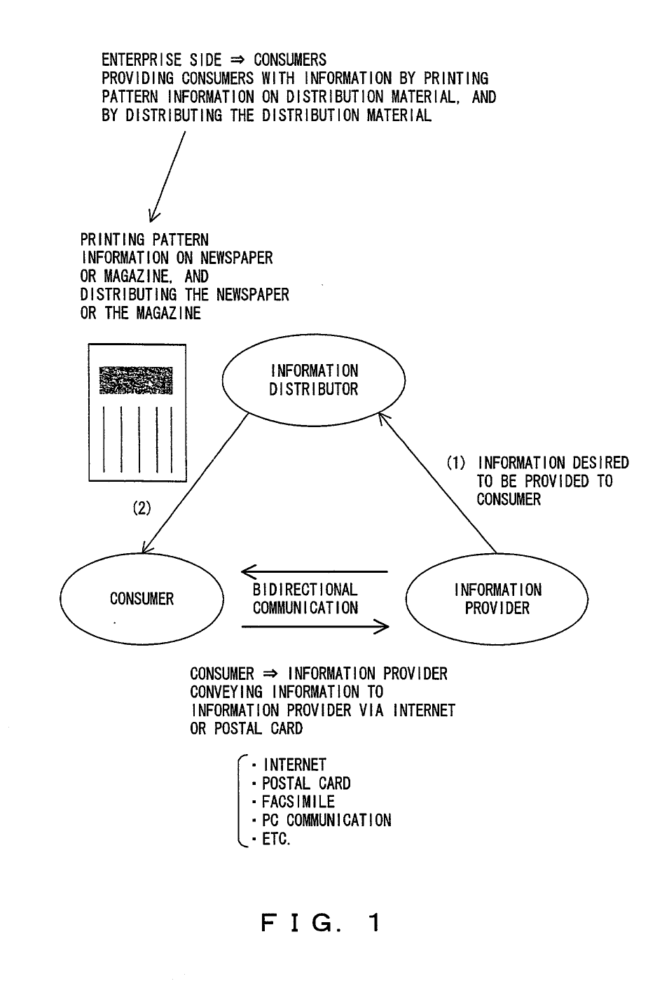

FIG. 1 explains the fundamental principle of the preferred embodiment according to the present invention. Numerals (1), (2), . . . etc. in the following description correspond to those in the drawings.

In this preferred embodiment, 1) information (characters, a moving image, a still image, audio data, etc.) that an enterprise side (an information provider) conveys to a consumer side, 2) a transmission destination of information that the consumer side conveys to the enterprise side, and 3) a program for identifying an environment surrounding the consumer side, a conveyance method used by the consumer side, a terminal on the consumer side, and the like are converted into non-readable and reversibly restorable pattern information, and stored. An information distributor such as a newspaper publishing company, a magazine publisher, etc. prints the pattern information on a magazine, a newspaper, etc., and distributes the printed matter to consumers.

On the consumer side, the pattern information obtained as the printed matter is read with an optical reading device such as a scanner, etc., the read information is restored by being decoded with an application program that is distributed beforehand, and the restored information is displayed on a computer.

Firstly, an enterprise side converts various information to be conveyed to a consumer, such as the contents of a questionnaire, etc., into non-readable and reversibly restorable pattern information, and passes the converted information to an information distributor along with an advertisement fee so as to request the distributor to carry the information [(1)]. The information distributor such as a newspaper publishing company, a magazine publisher, an advertising agency, etc. prints and carries the information received from the information provider in a medium such as a magazine, a newspaper, an advertisement leaflet, etc., and distributes the medium to consumers. Not the information provider, but the information distributor may convert information desired to be conveyed into pattern information, and print the pattern information on a distribution material.

The consumer who obtains the distribution material reads this pattern information with an optical reading device such as a scanner, etc., and restores the read data on a computer, so that the consumer can receive the information included in the pattern information from the enterprise side [(2)]. Then, the consumer side returns a reply to the information displayed on the computer directly or via the distributor (if the distributor collects replies and passes them to the information provider).

When the consumer side that receives the information from the enterprise side returns some reply information to the received information, the enterprise side must present the transmission destination (address) of the reply information to the consumer. Here, as an information conveying method from a consumer to an enterprise, a network communication such as an Internet communication, a personal computer communication, mail such as a postal card, etc., facsimile, a telephone call, etc. can be considered. However, other methods may be available. At this time, the storage program included in the pattern information determines the conveyance method that the consumer uses, and presents the information about the transmission destination of the reply information, which suits the conveyance method, to the consumer. Then, the consumer transmits the information by using the presented information about the transmission destination.

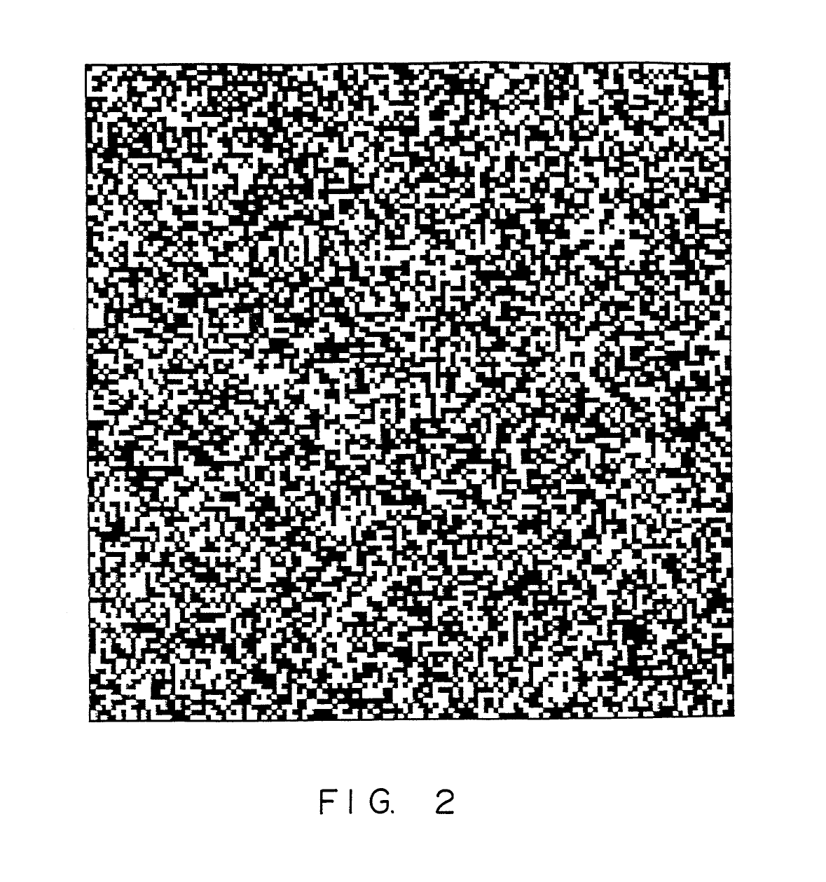

FIG. 2 exemplifies pattern information used in the information conveying system according to this preferred embodiment.

The pattern information is intended to record digital data with a black-and-white pattern like a barcode. With the barcode, information is recorded only in the horizontal direction (one-dimensionally) . In the meantime, the pattern information is characterized in that the amount of information which can be recorded per unit area is significantly increased in comparison with the conventional barcode by recording information two-dimensionally, that is, in the horizontal and vertical directions. Note that multidimensional code whose information amount is increased by using a color difference, etc. may be available as the pattern information, other than a method recording information with a black-and-white pattern.

Additionally, the density of the pattern information can be improved in proportion if the resolution of an optical reading device such as a scanner, etc., which reads a pattern from printed matter, is high. Therefore, the amount of information stored can be increased with an improvement in the performance of the optical reading device. For example, pattern information with a density that can be read by an optical reading device of approximately 300 dpi can store information of approximately 1 to 2 k bytes per several-centimeter square. Also in this case, the density of information is much higher than that in the case where characters are merely printed. For example, if a pattern with a recording density, which can be read by an optical reading device of approximately 1200 dpi, is used as a result of an improvement in the performance of the optical reading device, the amount of information, which is several to several-ten times, can be stored per identical area of pattern information.

Diversified methods are proposed as a method recording information with pattern information from various points of view. The pattern information used in this preferred embodiment does not particularly depend on a single recording method. A suitable method is selected and used depending on contents to be recorded, a print target, etc.

This pattern information can also store binary data. Therefore, as information that an enterprise side can convey to a consumer side by printing pattern information, information implemented by audio data, a moving image, a network address such as a URL, etc., program data, and the like are available in addition to information implemented by characters of conventional printed matter, a still image, and the like. As described above, non-readable and reversibly restorable pattern information is used, whereby multimedia information such as audio, a still image, a moving image, etc., or information that uses various information such as a program, etc., and is more attractive than conventional information, etc. can be provided to consumers in addition to character information. For instance, if such information is used for a questionnaire, an enterprise side can expect to receive replies from a lot more consumers.

Additionally, a consumer side can enjoy a variety of attractive information other than a questionnaire. Also, a questionnaire result can be transmitted with a transmission method that is suitable for a consumer.

Furthermore, by using pattern information, paper space occupied to print information of the same amount can be reduced in comparison with a conventional method with which a questionnaire is printed on a paper sheet unchanged. Even on a paper sheet printed in black and white, such as a newspaper, information such as a color image, video, etc. can be stored in pattern information, and information desired to be conveyed to consumers can be appealed to the consumers much more. Normally, a fee for carrying information in a newspaper, etc. is proportional to its area, and color printing costs higher than black-and-white printing. With pattern information, a higher effect can be expected at less cost in comparison with a conventional method.

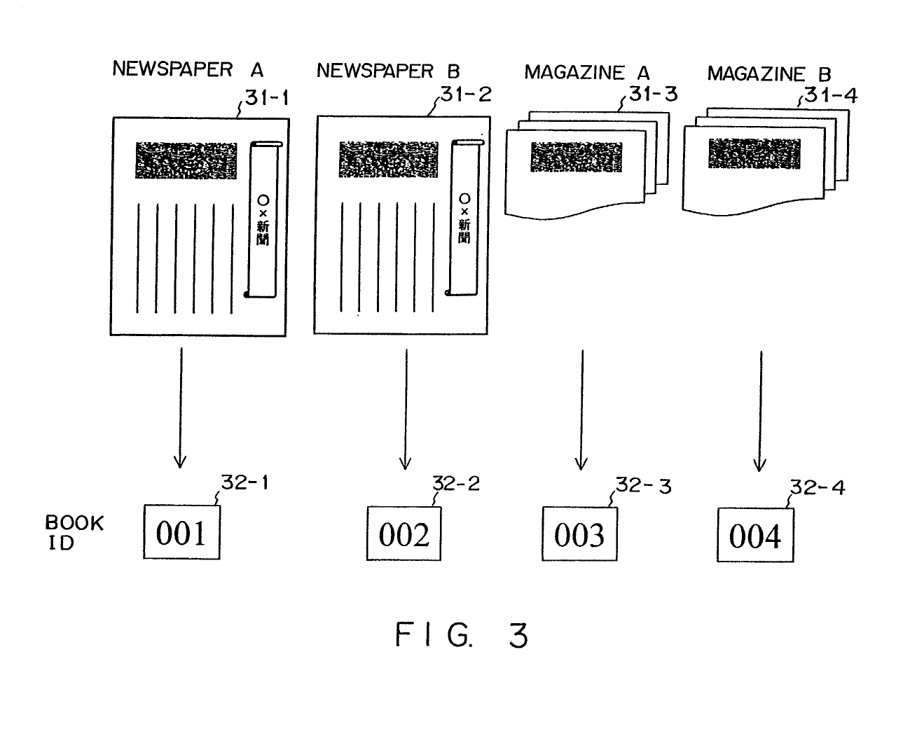

Next, BOOK IDs are explained with reference to FIG. 3.

As a distribution material on which pattern information is printed, a newspaper, a magazine, a brochure at a store, an advertisement leaflet, etc. are considered. Unique numbers (BOOK IDs) are assigned respectively to distribution materials 31, the unique numbers are stored within pattern information, and the distribution materials 31 are distributed to consumers.

In FIG. 3, unique numbers 001, 002, 003, and 004 are assigned as BOOK IDs 32 respectively to the distribution materials 31-1 through 31-4 of four types such as newspapers A and B, and magazines A and B. Each of the BOOK IDs 32 corresponding to each type of the publications is recorded in the pattern information that is printed on each of the publications.

When a questionnaire result is returned from a consumer, also the corresponding BOOK ID 32 is returned along with the result, so that the information about which of the distribution materials 31 the consumer reads and applies to the questionnaire can be obtained, and a publicity effect of each of the distribution materials 31 can be examined.

Additionally, such unique numbers are predetermined respectively for the types of a questionnaire and stored in pattern information, whereby questionnaire results can be automatically classified and added up by identifying the types of the questionnaire according to the unique numbers, even if the contents of the questionnaire include the plurality of types.

Next, information conveyance from a consumer side to an enterprise side, which is performed by the information conveying system according to this preferred embodiment, is explained.

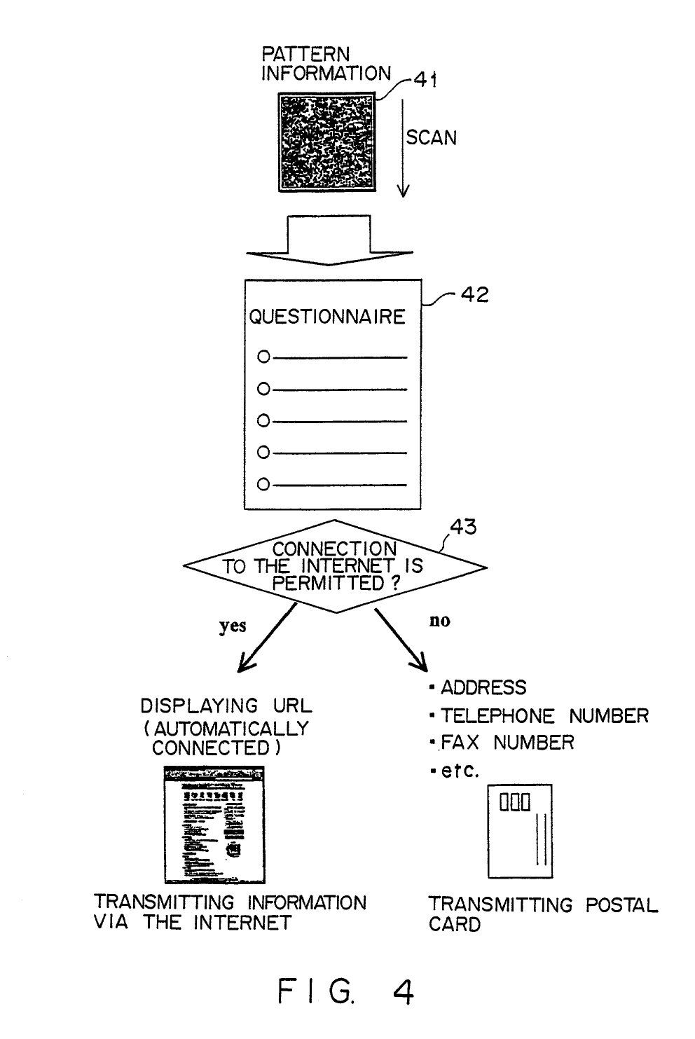

FIG. 4 explains the information conveyance from a consumer to an enterprise side in this preferred embodiment.

As a method conveying information from a consumer to an enterprise side, an Internet communication, a personal computer communication, mail such as a postal card, etc., facsimile, a telephone call, etc. are considered. In this preferred embodiment, a storage program 43 is included in pattern information 41 printed on a distribution material.

This storage program 43 performs the processes for smoothly conveying information between enterprise and consumer sides, for example, a process for restoring information such as a questionnaire, etc., which is to be displayed on a computer of a consumer by using each information within pattern information, a process for making a consumer select a method conveying a reply to a questionnaire, which is suitable for the circumstances of the consumer, and the like.

If the storage program 43 is configured as a single program, the size of the program code becomes large. Therefore, the storage program 43 is configured as a program embedded in an application program for restoring pattern information. Or, the storage program 43 may be configured as a control code for merely issuing operation instructions to an application program, which performs an actual process.

The storage program 43, for example, inquires of a consumer as to whether or not to make a connection to the Internet. If the consumer permits the connection, the storage program 43 makes the connection to the Internet, and transmits a reply to a questionnaire 42 restored from the pattern information 41, or the like to a server on an enterprise side. At this time, the storage program 43 examines the type of the terminal used by the consumer, that is, a personal computer (a desktop personal computer, a notebook computer, a hand-held PC, etc.), a cellular phone or a PHS (Personal Handyphone System), a digital home electrical appliance that can present information, etc., and makes a connection to a URL suitable for the type of the terminal. If the type of the terminal is a cellular phone, a URL may differ depending on a common carrier. Therefore, the type of the cellular phone is also identified.

Additionally, if the computer of the consumer is under circumstances where a connection cannot be made to the Internet, or if the consumer does not permit a connection to the Internet because he or she does not desire to make the connection, the storage program 43 displays a transmission destination (an address), a facsimile number, etc., to which a reply to a questionnaire is mailed or transmitted.

Furthermore, the storage program 43 may first inquire of a consumer as to whether or not a consumer makes a connection to the Internet, make a connection to a Web page on the Internet, which is specified within pattern information, if the consumer permits the connection, and present the contents of a questionnaire on the Web page. Besides, a reply may be made to the questionnaire on the Web page.

Here, an Internet communication is taken as an example. However, other network communications such as a personal computer communication, etc. may be used.

Next, the flow of the entire information conveying system according to the first preferred embodiment is explained.

The first preferred embodiment is an implementation in the case where an information conveying system is used to conduct a questionnaire.

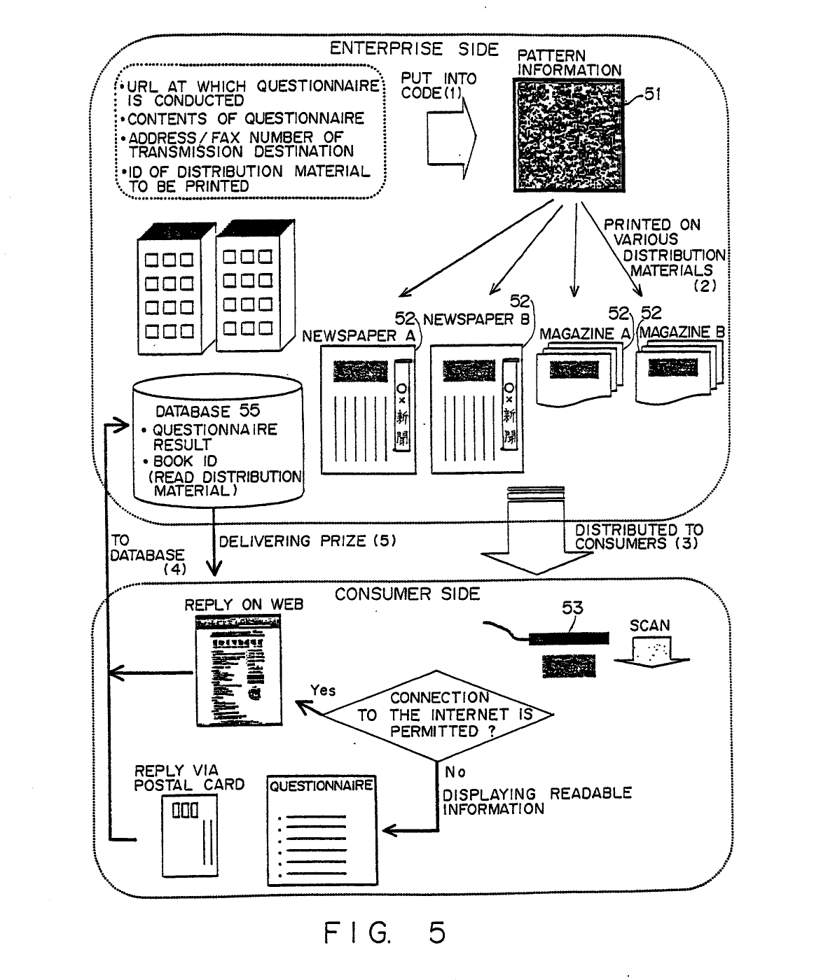

FIG. 5 explains the procedures of the information conveying system according to the first preferred embodiment.

In this figure, an information provider and an information distributor are collectively depicted as one. In this preferred embodiment, however, the information provider and the information distributor may be configured to be identical or separate. Additionally, the information distributor may collect a reply from a consumer side, and notify the information provider of a result of adding up replies from consumers. In this case, the consumer side returns a reply to the information distributor.

The enterprise side converts into pattern information 51 the contents of a questionnaire that is generated on a character basis, a URL of a Web page describing the contents of the questionnaire, information that the enterprise side desires to convey to the consumer side, information of a return destination for returning a result of the questionnaire, such as a URL, etc., a storage program, and the like [(1)].

The converted pattern information 51 is printed on distribution materials 52 such as newspapers, magazines, an advertisement leaflet, a brochure at a store, etc. [(2)], and the distribution materials are distributed to consumers [(3)].

A consumer who receives any of the distribution materials 52 reads the printed pattern information with an optical reading device such as a scanner, etc. or a dedicated reading device 53, and restores the read information. The restored code includes a storage program 54, which inquires of the consumer as to whether or not to make a connection to a network such as the Internet. Here, either of the following operations is performed according to a reply result of the consumer.

1) If a connection is made to the network, the type of a terminal is examined, and the connection is made to the Web page indicated by a URL corresponding to the type of the terminal among URLs stored in the pattern information 51. A questionnaire is prearranged on the Web page, and a questionnaire result replied by the consumer is stored in a database of the enterprise.

2) If a connection is not made to the network, a questionnaire (the same as a Web page) among readable information stored in the pattern information is presented to the consumer. At the same time, an address or a facsimile number of a transmission destination is presented based on an assumption that a questionnaire result replied by the consumer is transmitted via a postal card or facsimile.

After the consumer replies the questionnaire, he or she transmits the questionnaire result to the enterprise side by using a communication of the network such as the Internet, a postal card, facsimile, or a different method [(4)]. The enterprise side adds up questionnaire results and registers an added up result in a database 55.

Then, the enterprise side selects a prize draw winner from among consumers who have returned replies to the questionnaire and are registered to the database, and delivers a prize to the selected consumer [(5)]. Contents such as an image, music, a program, etc., may be available as a prize other than goods. In this case, these contents may be prestored in an application program or pattern information, and a keyword or a password for extracting the contents of a prize from the application program or the pattern information may be transmitted to a prize draw winner.

As described above, each information is printed as pattern information on a distribution material in this preferred embodiment, so that the following effects can be produced.

A consumer side can omit troublesome operations for making a connection, such as typing a URL, etc., if the consumer side is under circumstances where a connection can be made to a network. Even if the consumer side is under circumstances where a connection cannot be made to the network, the consumer can apply to a questionnaire in a form suitable for the environment surrounding the consumer, such as using a postal card, facsimile, etc.

A storage program included in pattern information automatically determines the conveyance method used by a consumer, and makes the consumer select a method suitable for his or her circumstances, whereby an enterprise side can make the consumer participate in a questionnaire in a form suitable for his or her circumstances, for example, depending on whether or not a connection can be made to a network.

If a questionnaire is conducted on a paper to be distributed, a lot of space of a distribution material is occupied. With pattern information, paper space to be occupied can be reduced. Even on a paper sheet printed in black and white like a newspaper, information such as a color image, video, audio, etc. can be stored in the pattern information, whereby information desired to be conveyed to consumers can be appealed much more. Accordingly, a higher effect can be obtained with an advertisement fee less than a conventional method.

Next, an information conveying system according to a second preferred embodiment is explained.

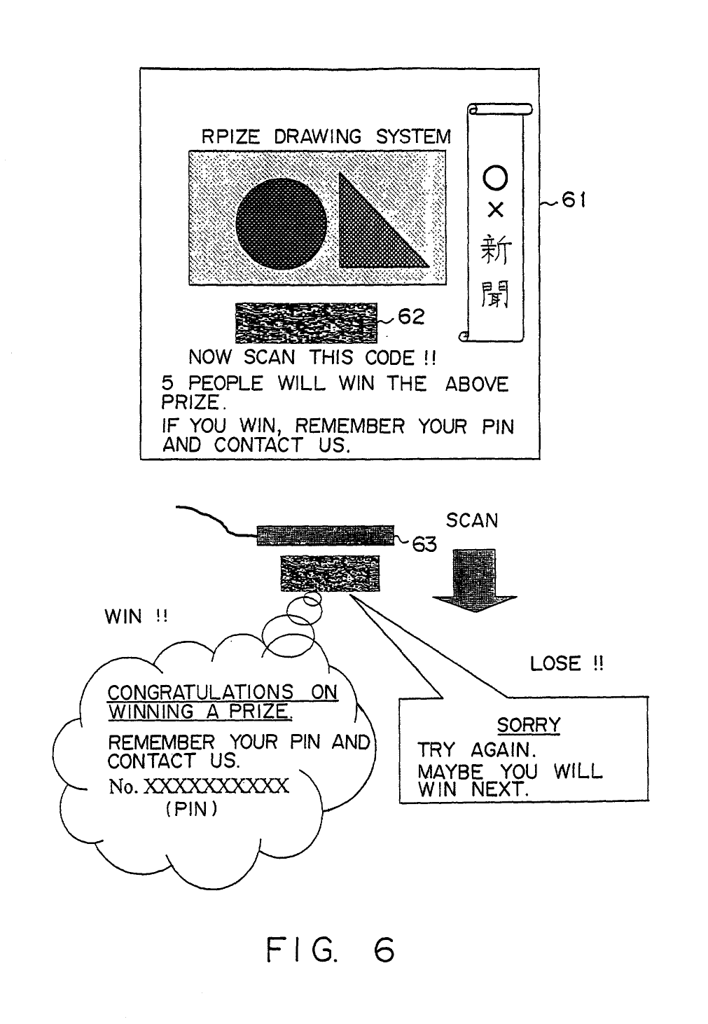

FIG. 6 is a conceptual drawing of the second preferred embodiment.

The information conveying system according to the second preferred embodiment is a system with which a consumer who restores pattern information can immediately learn the winning/losing of a prize, as with an instant lottery.

In the second preferred embodiment, information that an enterprise side desires to notify to consumers, such as an advertisement, etc., is converted into pattern information, the converted information is printed on a distribution material 61, and the distribution material 61 is distributed to the consumers in a similar manner as in the first preferred embodiment. Then, a consumer scans pattern information 62 printed on the distribution material 61 with an optical reading device 63, and restores the contents of a questionnaire, so that the information within the pattern information 62 is presented, and at the same time, winning/losing of a prize is immediately notified to the consumer.

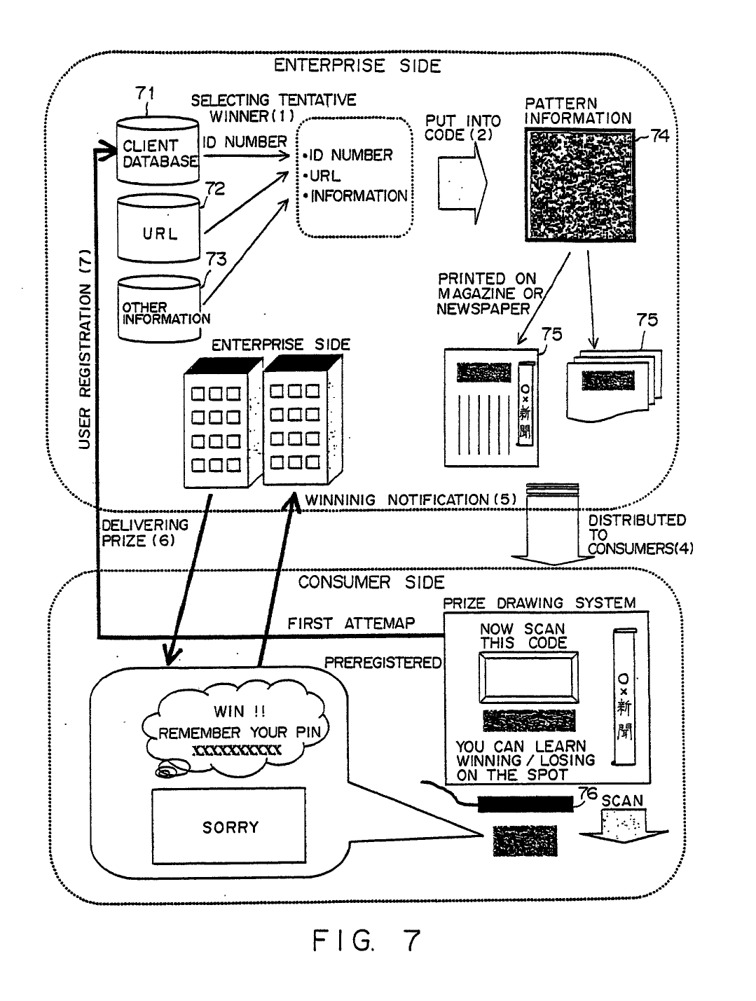

FIG. 7 explains the procedures of the information conveying system according to the second preferred embodiment.

Also in this figure, an information provider and an information distributor are collectively shown as one entity. However, the information provider and the information distributor may be configured to be identical or separate in a manner similar to that in the first preferred embodiment.

With this system, a consumer is made to preregister his or her personal information, and an ID number is issued in return for the registration of the personal information. An enterprise side puts the personal information into a database record, registers the personal information to a client database 71 along with the issued ID number, and manages the information. On the consumer side, this ID number is set in an application program for restoring pattern information when the personal information is registered.

When a prize competition is conducted, an enterprise side first selects a winner from the client database 71 in which information about consumers are accumulated, extracts the information identifying the winner, such as an ID number, etc., and defines the extracted information to be information for determining the winning/losing of a prize [(1)].

Next, the enterprise side converts the information for determining the winning/losing of a prize, such as an ID number selected from the client database 71, or the like into pattern information 74 in addition to a URL 72 of a Web page, information 73 that the enterprise side desires to convey to the consumer side, information about a return destination for returning a questionnaire result, etc., such as a URL, etc., a storage program, etc., which are similar to those in the first preferred embodiment [(2)]. The pattern information 74 is printed on a distribution material 75 such as a newspaper, a magazine, an advertisement leaflet, a brochure at a store, etc. [(3)], and the distribution material is distributed to consumers [(4)].

A consumer that obtains the distribution material 75 reads the printed pattern information 74 with an optical reading device such as a scanner, etc. or a dedicated reading device 76, and restores the read information. At this time, the storage program included in the pattern information is restored, a comparison is made between the ID number of the consumer who has restored the pattern information and the ID number within the pattern information, and the winning/losing of a prize is notified to the consumer. In this way, the consumer can enjoy the prize competition by which the winning/losing of a prize can be verified on the spot, as with an instant lottery.

The storage program included in the pattern information makes a comparison between the information for determining the losing/winning of a prize, such as the ID number included in the pattern information 74, or the like, and the identification information such as the ID number of the consumer who has restored the pattern information 74 which is set in the application program for restoring pattern information. If these information mismatch, losing of the prize is presented to the consumer by using the information for notifying losing among the information included in the pattern information 74. If these information match, winning of the prize is presented to the consumer by using the information for notifying winning among the information included in the pattern information 74. At this time, prize image data, etc. may be included in the pattern information 74 as the information for notifying winning, and the prize image, etc. may be displayed for the consumer along with the winning notification. Or, a particular number (PIN) may be included in the information for notifying winning and this number is presented with winning of the prize. And the consumer who wins the prize may notify the enterprise side of the PIN, so that the winner can be identified. In this preferred embodiment, an ID number assigned when a user is registered is used as the information for determining the winning/losing of a prize. However, a serial number or the like may be prestored in an application program to be distributed to consumers, and used as a replacement of the ID number.

Next, the storage program inquires of the winner as to whether or not to make a connection to a network such as the Internet. Here, either of the following operations is performed according to a reply result of the consumer.

1) If the connection is made to the network, the type of the terminal is examined, and the connection is made to the Web page indicated by a URL corresponding to the type of the terminal included in the pattern information 74. The consumer who has won the prize notifies the enterprise side of his or her winning [(5)].

At this time, the enterprise side uses the personal information of the consumer and the ID number, which are registered in the database 71, in order to verify the winner. The winning of the consumer is settled only after the ID number that the enterprise side selected and the ID number of the consumer who notifies the winning match. Or, the consumer who notifies his or her winning may be made to present the PIN displayed on the computer screen, and the enterprise side may verify the PIN, so that the winner can be settled. The enterprise side then delivers the prize to the consumer whose winning has been settled [(6)].

2) If the connection is not made to the network, a method notifying the enterprise side of the winning among the information included in the pattern information 74 is presented. For example, an address or a facsimile number of a transmission destination is presented to notify the enterprise side of the winning via a postal card or facsimile, and the consumer notifies the enterprise side of his or her winning with any of these methods [(5)].

The enterprise side that has received the winning notification determines whether or not a match is found between the consumer who has transmitted the notification and the consumer that the enterprise side selected. Namely, a comparison is made between the notification information transmitted from the consumer and the winner information within the database held by the enterprise side, or the PIN. If a match is found between the consumer that has transmitted the notification and the selected consumer, the enterprise side settles the winning of the consumer. Then, the enterprise side delivers a prize to the consumer whose winning has been settled [(6)]. In a similar manner as in the first preferred embodiment, contents such as an image, music, a program, etc. may be available as the prize other than goods, and a keyword or a password for extracting prize contents from an application program or pattern information may be transmitted to the winner.

If the consumer who restored the pattern information has not yet registered personal information and does not possess an ID number, the storage program inquires of the consumer as to whether or not to make a connection to a network such as the Internet, etc. According to a reply of the consumer, either of the following operation is performed.

1) If the connection is made to the network, the type of the terminal is examined, and the connection is made to the site indicated by a URL corresponding to the type of the terminal among URLs included in the pattern information. Then, an ID number is automatically obtained from this site [(7)].

2) If the connection is not made to the network, methods for obtaining an ID number from the information included in the pattern information are presented on the computer screen of the consumer. For example, a transmission destination of mail, such as a postal card, etc. or a facsimile number is displayed on the screen, and a contact is made with any of these methods, so that an ID number is transmitted at some future date [(7)].

By building the system configuration shown in FIG. 7 as described above, a consumer can take enjoyment like a sort of an instant lottery, by which a consumer can determine the winning/losing of a prize on the spot.

Additionally, the storage program included in the pattern information automatically determines the environment surrounding the consumer, for example, whether or not a connection can be made to a network at the time of winning notification. If the consumer is under the circumstances where the connection can be made to the network such as the Internet, etc., operations such as winning notification, etc. can be simplified, and troublesome operations of the consumer can be omitted. If the consumer is under the circumstances where the connection cannot be made to the network, winning notification can be made with a different method that suits the environment surrounding the consumer, such as a postal card, facsimile, etc.

Furthermore, the enterprise side gives a consumer enjoyment like an instant lottery, thereby acquiring a new consumer. Still further, an advertising effect can be expected by including an advertisement in pattern information, or business getting an equivalent return can be conducted by including an advertisement or a notification of a different company.

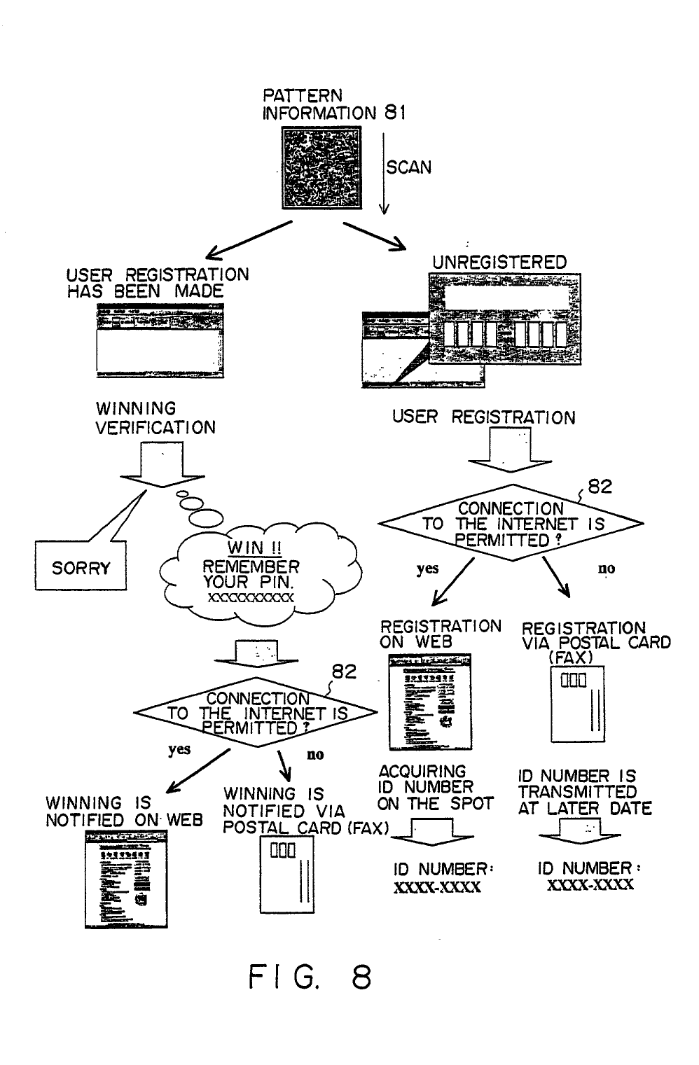

FIG. 8 shows the information conveyance from the consumer side to the enterprise side in the second preferred embodiment shown in FIG. 7.

When pattern information 81 printed on a distribution material is scanned and restored, a storage program 82 included in the pattern information 81 attempts to read the ID number of the consumer in order to verify if the consumer wins a prize.

If the consumer has made user registration and possesses the ID number as a result of the user registration, the winning/losing of the consumer is verified by making a comparison between this ID number and the ID number within the pattern information 81. Then, the storage program 82 notifies the consumer of the winning/losing of the prize, and inquires of the consumer as to whether or not to make a connection to the Internet if the consumer wins the prize. If the connection to the Internet is permitted as a result of the inquiry, the consumer notifies his or her winning on a Web page. If the consumer is under the environment where the connection cannot be made to the Internet, the consumer notifies the enterprise side of his or her winning via a postal card, facsimile, etc. as with a conventional method.

If the ID number cannot be read out when the winning/losing of a prize is verified, the storage program 82 determines that an ID number has not been issued to the consumer yet, and inquires of the consumer as to whether or not to make a connection to the Internet. If the connection is permitted as a result of the inquiry, the storage program 82 lets the consumer make user registration on a Web page. In this case, user registration is immediately made, and the consumer can obtain an ID number on the spot. If the connection is not permitted, the storage program 82 presents how to make user registration with a different method such as a postal card, facsimile, etc., to the consumer. A registered ID number is transmitted to the consumer at some future date in this case.

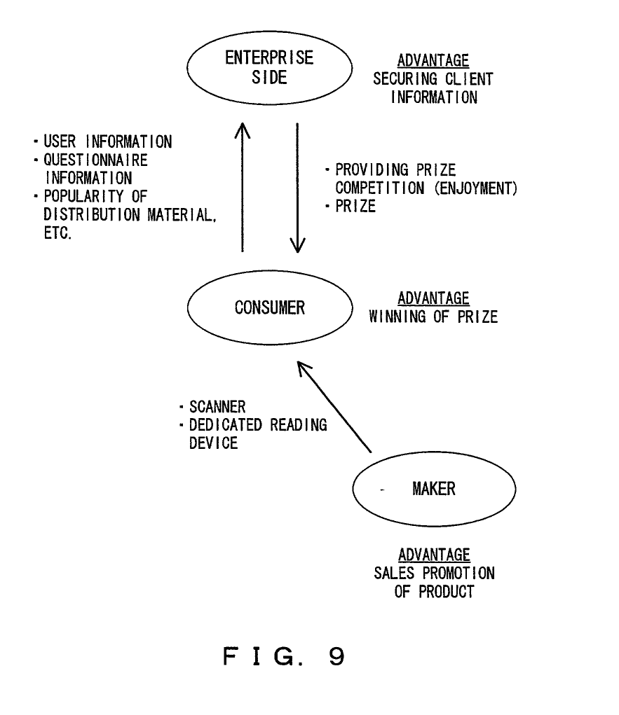

FIG. 9 shows the advantages that an information conveying system according to the present invention brings to enterprise and consumer sides, and a maker.

With this system, the enterprise side has an advantage that user information such as personal information of a consumer, etc., information of a questionnaire result, etc., information of a distribution material, etc. can be collected from consumers, and various client information can be secured.

In the meantime, the consumer side can get enjoyment as a prize competition or a prize from the enterprise side if the consumer wins the prize, or can take enjoyment in determining whether or not the consumer wins a prize even if the consumer does not win the prize. Furthermore, a storage program included in pattern information assists the operations of the consumer by making the consumer select a conveyance method suiting his or her circumstances, whereby the consumer can make user registration, winning notification, etc., which are conventionally troublesome to consumers, with simplified processes.

Still further, a consumer purchases a general-purpose scanner or a dedicated device reading pattern information in order to participate in this system, whereby a maker can promote the sales of a product.

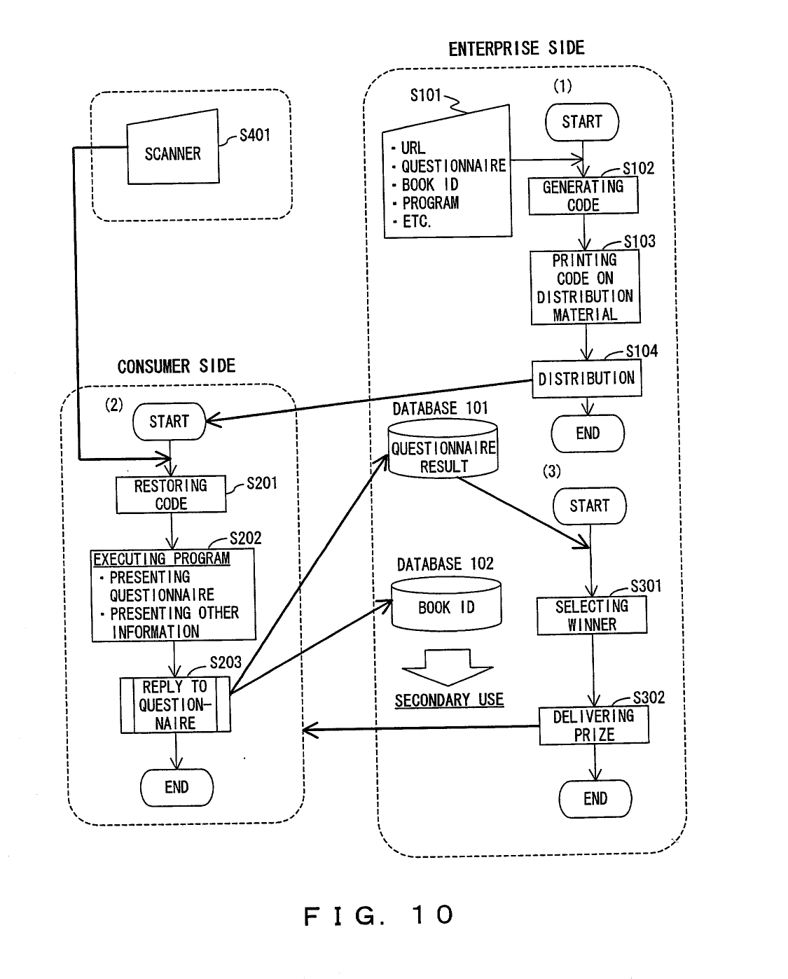

FIG. 10 is a flowchart showing the process performed by the information conveying system according to the first preferred embodiment.

Process flows (1), (2), and (3) shown in this figure are process flows that sequentially represent the flowchart of the system according to the first preferred embodiment. Process flow (1) indicates a process flow until an enterprise side distributes a distribution material including the contents of a questionnaire. Process flow (2) indicates a process flow until a consumer who receives the distribution material replies to the questionnaire, and notifies the enterprise side of a result of the questionnaire. Process flow (3) indicates a process flow until the enterprise side that receives the notification settles a winner among consumers who reply to the questionnaire, and delivers a gift. Explanation is provided sequentially from Process flow (1).

Process Flow (1)

Process flow (1) is a flowchart until information that an enterprise side desires to convey to a consumer side is converted into pattern information when the enterprise side starts to conduct a questionnaire, and a distribution material on which the pattern information is printed is distributed to consumers.

The enterprise side first selects information to be converted into pattern information, for example, information that the enterprise side presents to consumers, such as the contents of a questionnaire, etc., notification destination information such as a URL, etc., a storage program, and the like as step S101. At this time, the enterprise side defines a BOOK ID shown in FIG. 3 for each distribution material on which the pattern information is printed, and registers the BOOK ID to a database 102. Then, the enterprise side converts the information selected in step S101 and the BOOK ID into pattern information as step S102.

Next, the enterprise side prints an advertisement including the pattern information converted in step S102 on a distribution material to be distributed to consumers as step S103, and distributes this distribution material to the consumers as step S104. Here, the operations of Process flow (1) are terminated.

Process Flow (2)

Process flow (2) is a flowchart showing the process performed by an application program for restoring pattern information on a consumer side, and a storage program included in the pattern information on a consumer side. The application program for restoring pattern information is distributed to consumers beforehand.

A consumer who obtains the distribution material, on which the pattern information is printed, first reads the pattern information with an optical reading device such as an image scanner, etc., or a dedicated reading device in step S401.

The application program restores the code pattern information read in step S401 as step S201. The data restored from the pattern information includes the information that the enterprise side presents to consumers, and the storage program. The application program executes the storage program and the information included in the pattern information in their storage order as step S202.

In step S203, the application program or the storage program presents a questionnaire on the computer screen of a consumer. When the consumer replies to the presented questionnaire, the contents of the reply are notified to the enterprise side as a questionnaire reply notification with a notification process to be described later, and the notified contents are stored in a database 101 on the enterprise side.

Process Flow (3)

Process flow (3) is a flowchart showing the process until the enterprise side that receives the questionnaire reply notification from the consumer side settles a prize draw winner among consumers who reply to the questionnaire, and delivers a prize.

In step S301, a winner is selected from among the information of the consumers who reply to the questionnaire, which are stored in the database 101 on the enterprise side, for example, by using a random number.

Then, in step S302, the prize is delivered to the winner. Here, the process is terminated. Thereafter, the questionnaire results accumulated in the database 101 are added up by using BOOK IDs stored within the database 102. Additionally, the personal information of the consumers, which are transmitted along with the questionnaire results, are secondarily used. Furthermore, the advertisement effect of each distribution material is analyzed by examining the tendency of the consumers who return the questionnaire replies by using the BOOK IDs stored within the database 102.

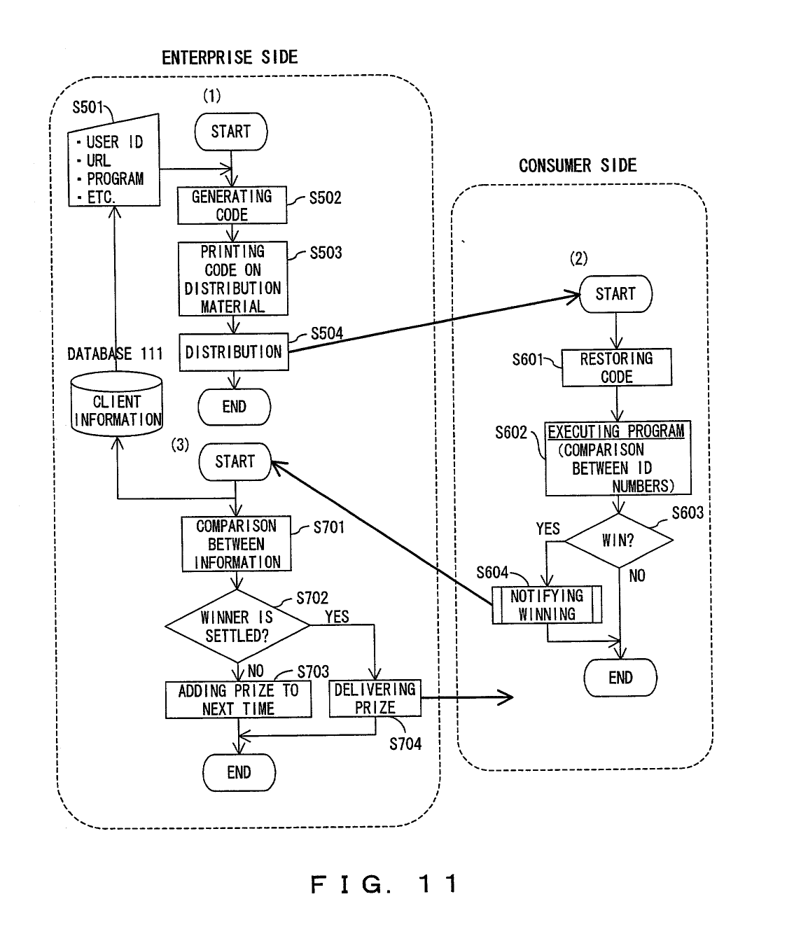

FIG. 11 is a flowchart showing the process performed by the information conveying system according to the second preferred embodiment.

Process flows (1), (2), and (3) shown in this figure are process flows that sequentially represent the flowchart of the system according to the second preferred embodiment. Process flow (1) indicates a process flow until an enterprise side generates pattern information, and distributes a distribution material on which the pattern information is printed to consumers. Process flow (2) indicates a process flow until a consumer who receives the distribution material determines the winning/losing of a prize, and notifies the enterprise of his or her winning if the consumer wins the prize. Process flow (3) indicates a process flow until the enterprise side determines whether or not a match is found between the consumer who notifies his or her winning and the consumer that the enterprise side selects, settles the winning of that consumer if a match is found, and delivers a prize to the consumer.

Process Flow (1)

Process flow (1) is a flowchart showing the process until the enterprise side generates pattern information, and distributes a distribution material on which the pattern information is printed to consumers.

As step 501, the enterprise side first selects information to be converted into pattern information, such as information that the enterprise side presents to consumers, notification destination information such as a URL, etc., a storage program, and the like. Additionally, the enterprise side decides a prize draw winner among consumers whose personal information are registered to a client database 111 with a method, for example, using a random number, extracts the information for identifying the decided consumer, such as an ID number, etc., from the client database 111. Then, as step S502, the enterprise side converts the information selected in step S501, and the information for identifying the decided consumer into pattern information.

Next, as step S503, the enterprise side prints an advertisement including the pattern information converted in step S502 on a distribution material to be distributed to consumers, and distributes the distribution material to the consumers. Here, the operations of the process flow (1) are terminated.

Process Flow (2)

Process flow (2) indicates a process flow until a consumer who receives the distribution material determines the winning/losing of a prize, and notifies the enterprise of his or her winning if the consumer wins the prize. An application program for restoring pattern information, which is distributed to the consumers beforehand, or a storage program included in the pattern information performs this process.

The consumer who receives the distribution material on which the pattern information is printed reads the printed pattern information by using an optical reading device such as an image scanner, etc. or a dedicated reading device, and the application program restores the read pattern information, as step S601.

Then, the application program sequentially executes and processes the storage program and other information, which are restored from the pattern information, in their storage order. As a result, the information that the enterprise side presents to the consumers, such as the information of characters, audio, an image, etc., are presented to the consumers.

Next, the application program or the storage program references the ID number, which is set in the application program, of the consumer who restores the pattern information, and determines whether or not the consumer wins the prize by making a comparison between the referenced ID number and the ID number that is selected by the enterprise side in step S501 and included in the pattern information, as step S603. If both of the ID numbers match (“YES” in step S603), the application program or the storage program notifies the consumer of his or her winning, and notifies the enterprise side of the winning of the consumer with a winning notification process for the enterprise side, which will be described later, as step S604. Here, the process is terminated. At this time, a PIN may be presented to the consumer along with the winning notification, and the consumer may notify the enterprise side of the PIN, so that the enterprise side can settle the winning of the consumer. If both of the ID numbers do not match (“NO” in step S603), the application program or the storage program presents his or her losing to the consumer. Then, the process is terminated.

If an ID number is not set in the application program in step S603, it is recognized that the consumer has not yet made user registration, and an ID number has not yet been assigned. Therefore, an ID number acquisition method is presented. If the computer of the consumer can make a connection to a network, the connection is made by using ID acquisition information that is included in the pattern information and contains a connection destination such as a URL, etc., and an ID number is automatically assigned via the network. If the computer of the consumer cannot make the connection to the network, acquisition information with a different method, which is included in the pattern information, is presented.

Process Flow (3)

Process flow (3) is a flowchart showing the process until the enterprise side that receives the winning notification from the consumer verifies the winner, and delivers a prize.

Upon receipt of the winning notification from the consumer, the enterprise side verifies whether or not a match is found between the consumer who has transmitted the notification and the consumer that the enterprise side itself selected in step S501 by making a comparison between the information such as the ID numbers, etc. as step S701.

The enterprise side makes a comparison between notification information such as a PIN, the ID number, the name of the consumer, etc., which have been notified by the consumer along with the winning notification, and the information of the consumer that the enterprise side selected as a winner within the database 111. As step S702, the enterprise side settles the consumer who has notified his or her winning as the winner, if both of the information match. If the winner is settled (“YES” in step S702), the enterprise side delivers the prize to the winner, as step S704. Here, the process is terminated.

If the winner cannot be settled or if the number of consumers who notify their winning is smaller than a planned number of winners, no winner is settled in step S703. In this case, the prize may be added to a prize at the next time.

With the process flows shown in FIG. 11, a quick and simple prize competition can be realized by omitting the troublesomeness of the consumer and the prize sponsor sides.

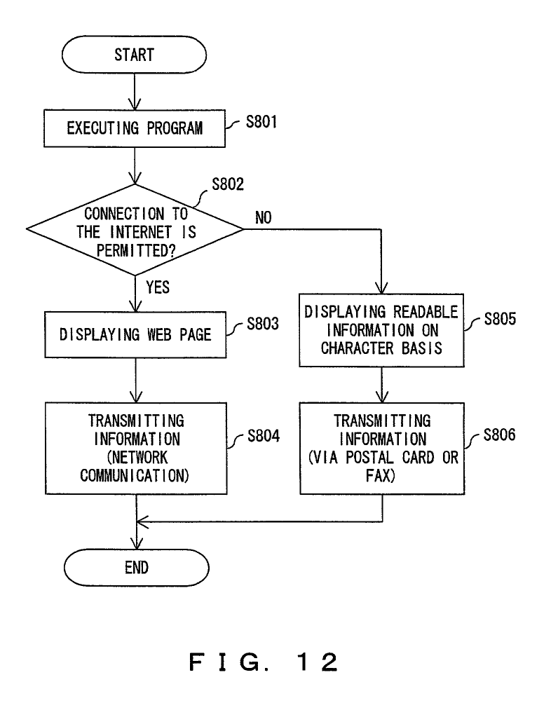

FIG. 12 is a flowchart showing the process for notifying information from the consumer to the enterprise side in step S203 of FIG. 10 or in step S604 of FIG. 11.

If a result of a reply to a questionnaire is notified from the consumer side to the enterprise side in the first preferred embodiment shown in FIG. 10, or if winning notification is made in the second preferred embodiment shown in FIG. 11, an application program executes the storage program for processing a notification, which is included in pattern information, as step S801.

This storage program inquires of the consumer as to whether or not to make a connection to a network such as the Internet, etc. as step S802.

If the connection is permitted as a result of the inquiry (“YES” in step S802), the storage program makes the connection to a corresponding site, and displays a Web page, as step S803. After information such as a result of a reply to the questionnaire, a winning notification, etc., is transmitted to the enterprise side via the network as step S804, the process is terminated. If the connection is not permitted by the consumer (“NO” in step S802), the storage program displays information required for making a notification with a method different from a network communication, such as a postal card, facsimile, etc. on a computer screen, as step S805. The consumer views this information, and notifies the enterprise side of the information with the method displayed in step S805, such as mail, facsimile, etc., as step S806. Then, the process is terminated. When the consumer inputs necessary information on the computer screen in step S804 or S805, a postal card or a paper sheet in a complete form, which the consumer can mail or transmit via facsimile, may be automatically printed and output.

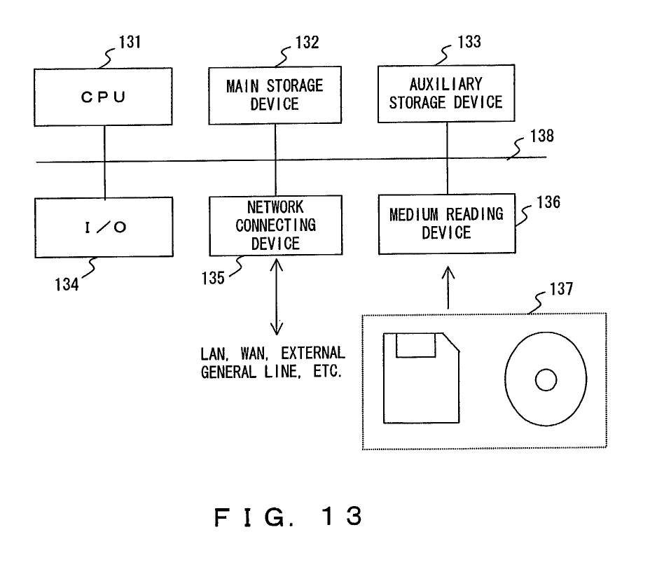

FIG. 13 shows an information processing system environment showing the configuration of a consumer side computer or that of an enterprise side server, which is used in an information conveying system according to any of the preferred embodiments.

The information processing system comprises a CPU 31, a main storage device 132, an auxiliary storage device 133, an input/output (I/O) device 134 such as a display, a keyboard, etc., a network connecting device 135 such as a modem, etc., and a medium reading device 136 reading the contents stored onto a portable storage medium such as a disk, a magnetic tape, etc., as shown in FIG. 13. These constituent elements are interconnected by a bus 138.

The information processing system shown in FIG. 13 reads a program and data stored onto a storage medium 137 such as a magnetic tape, a floppy disk, a CD-ROM, an MO, etc. with the medium reading device 136, and downloads the read program and data into the main storage device 132 or the auxiliary storage device 133. The CPU 131 executes the program with the data, so that the processes according to the preferred embodiments are implemented in a software manner.

Additionally, in the computer system shown in FIG. 13, application software may sometimes be replaced by using the storage medium 137 such as a floppy disk, etc. Accordingly, the present invention is not limited to an information conveying system or method. The present invention may be configured as a computer-readable storage medium 137 for causing a computer to execute the above described capabilities of the preferred embodiments according to the present invention, when being used by the computer.

In this case, storage media include, for example, a portable storage medium 146 such as a CD-ROM, a floppy disk (or an MO, a DVD, a removable hard disk, etc.), which can be inserted/ejected into/from a medium driving device 147, a storage means 142 (a database, etc.) within an external device (a server, etc.), to which a program and data are transmitted via a network line 143, a memory 145 (a RAM, a hard disk, etc.) within a main body 144 of an information processing device 141, and the like. The program stored onto the portable storage medium 146 or in the storage means 142 (a database, etc.) is loaded into the memory 145 (a RAM, a hard disk, etc.) within the main body 144, and executed.

As described above, according to the present invention, diverse information can be smoothly conveyed from an enterprise to a consumer side or vice versa. Additionally, the troublesomeness of the operations of both of the enterprise and the consumer sides can be reduced at that time.

Furthermore, the enterprise side can convey information to the consumer side more effectively and more cheaply than with a conventional method.

Still further, the present invention can provide a prize competition method that is not troublesome to a consumer and a sponsor, and allows the winning/losing of a prize to be verified on the spot as with an instant lottery.

Still further, the present invention can render assistance for information conveyance from a consumer to an enterprise side, which suits an environment surrounding the consumer, for example, by using a network if the consumer can use the network, or by a different method if the consumer cannot use the network.

Still further, pattern information is used, thereby reducing paper space to be occupied in comparison with a conventional method printing a questionnaire on a paper sheet unchanged.

Still further, information such as a color image, video, audio, etc. can be included in pattern information even on a paper sheet printed in black and white like a newspaper, whereby information desired to be conveyed to consumers can be appealed much more.

Still further, according to the present invention, an enterprise side can collect client information with higher effect than with a conventional method.

Still further, operations of a consumer, which are required to apply to a prize, can be simplified, and consumers can take enjoyment in a new prize method.

Still further, the present invention greatly contributes to the sales promotion of a product by a maker.

What is claimed is:

1. An information conveying system, in which an information provider side conveys information to a consumer side via a distribution material distributed by an information distributor, and a bidirectional information exchange between the information provider side and the consumer side is made, wherein:
at least one the information provider side and the information distributor side, comprising
a converting unit converting conveyance information conveyed from the information provider side to the consumer side into pattern information recording digital data; and
the consumer side, comprising
a restoring unit restoring the pattern information, and
a returning unit returning reply information of the conveyance information to at least one the information provider side and the information distributor side based on the conveyance information that said restoring unit restores from the pattern information.

2. A server in an information conveying system conveying conveyance information to a consumer side, and receiving a reply to the conveyance information, comprising:
a converting unit converting the conveyance information to be conveyed to the consumer side into pattern information; and
an accumulating unit accumulating information returned from the consumer side.

3. A terminal used by a consumer side in an information conveying system making a bidirectional information exchange between an information provider side and the consumer side, comprising:
a restoring unit restoring pattern information printed on a distribution material; and
a returning unit returning reply information to the information provider side based on conveyance information that said restoring unit restores from the pattern information.

4. An information conveying system, in which an information provider side conveys information to a consumer side via a distribution material distributed by an information distributor, and a bidirectional information exchange between the information provider side and the consumer side is made, wherein:
at least one the information provider side and the information distributor side, comprising
converting means for converting conveyance information conveyed from the information provider side to the consumer side into pattern information recording digital data; and
the consumer side, comprising
restoring means for restoring the pattern information, and
returning means for returning reply information of the conveyance information to at least one the information provider side and the information distributor side based on the conveyance information that said restoring means restores from the pattern information.

5. A server in an information conveying system conveying conveyance information to a consumer side, and receiving a reply to the conveyance information, comprising:
converting means for converting the conveyance information to be conveyed to the consumer side into pattern information; and
accumulating means for accumulating information returned from the consumer side.

6. A terminal used by a consumer side in an information conveying system making a bidirectional information exchange between an information provider side and the consumer side, comprising:
restoring means for restoring pattern information printed on a distribution material; and
returning means for returning reply information to the information provider side based on conveyance information that said restoring means restores from the pattern information.

7. An information conveying method with which an information provider side conveys information to a consumer side via a distribution material distributed by an information distributor side, wherein:
at least one of the information provider side and the information distributor side converts conveyance information to be conveyed from the information provider side to the consumer side into pattern information recording digital data; and
the consumer side restores the pattern information printed on the distribution material, and returns reply information of the conveyance information to at least one the information provider side and the information distributor side based on the conveyance information restored from the pattern information.

8. The information conveying method according to claim 7, wherein the conveyance information includes at least one of provision information that the information provider side provides to the consumer side, return information for returning the reply information, and a storage program determining an environment surrounding the consumer side.

9. The information conveying method according to claim 8, wherein
the provision information is multimedia information including at least one of character information, still image information, moving image information, and audio information.

10. The information conveying method according to claim 8, wherein
the storage program returns the reply information by making a connection to a network if the consumer side can make the connection to the network, or presents information required for returning the reply information with a method which does not make a connection to the network if the consumer side cannot make the connection to the network.

11. The information conveying method according to claim 8, wherein
the storage program identifies a terminal of the consumer side.

12. The information conveying method according to claim 7, wherein
the information provider side assigns a distribution material identifier for identifying a type of the distribution material to the distribution material, and converts the distribution material identifier into pattern information along with the conveyance information.

13. The information conveying method according to claim 7, wherein
the information provider side accumulates the reply information that the consumer side returns.

14. The information conveying method according to claim 7, wherein
the conveyance information includes questionnaire information for the consumer side, and the return information includes a reply result of the questionnaire information.

15. The information conveying method according to claim 14, wherein
the information provider side assigns an identifier to each type of the questionnaire information, and converts the identifier into pattern information along with the conveyance information.

16. The information conveying method according to claim 15, wherein
the return information includes the identifier along with the reply result, and the information provider side adds up the reply result by using the identifier.

17. The information conveying method according to claim 7, wherein
the conveyance information includes information for determining winning/losing of a prize, and a winning/losing determination program for determining winning/losing of a prize according to the information for determining the winning/losing of a prize, and identification information set on the consumer side.

18. The information conveying method according to claim 17, wherein
the winning/losing determination program immediately notifies the consumer side of a determination result when determining winning/losing of a prize.

19. The information conveying method according to claim 17, wherein
when the identification information is not set on the consumer side, the winning/losing determination program assigns the identification information via a network if the consumer side can make a connection to the network, or presents information required for assigning the identification information with a method which does not make a connection to the network if the consumer side cannot make the connection to the network.

20. An information conveying method, comprising:
restoring pattern information recording digital data printed on a distribution material; and
returning reply information to an information provider side based on conveyance information restored from the pattern information.

21. A computer-readable storage medium on which is recorded a program for causing a computer to execute a process, when being used by the computer, said process comprising:
converting conveyance information to be conveyed to a consumer side into pattern information recording digital data; and
storing and accumulating a reply to the conveyance information, which is returned from the consumer side, in a memory.

22. A computer-readable storage medium on which is recorded a program for causing a computer to execute a process, when being used by the computer, said process comprising:
restoring pattern information which records digital data, and is printed on a distribution material; and
returning reply information to an information provider side based on conveyance information that is restored from the pattern information and conveyed from the information provider side.

23. The computer-readable storage medium according to claim 21, said process further comprising
embedding a storage program into the program, if the conveyance information restored from the pattern information includes the storage program.

24. A distribution material on which pattern information recording digital data is printed, the distribution material including at least one of provision information that an information provider side provides to a consumer side, return information for returning reply information of the provision information, and a storage program for determining an environment surrounding the consumer side.

25. A computer data signal embodied in a carrier wave and representing control software, said control software comprising the operations of:
converting conveyance information to be conveyed to a consumer side into pattern information recording digital data; and
storing and accumulating a reply to the conveyance information, which is returned from the consumer side, in a memory.

26. A computer data signal embodied in a carrier wave and representing control software, said control software comprising the operations of:
restoring pattern information that is printed on a distribution material, and records digital data; and
returning reply information to an information provider side based on conveyance information that is restored from the pattern information and conveyed from the information provider side.
